(19) United States
(12) Patent Application Publication
(10) Pub. No.: US 2003/0137165 A1
(43) Pub. Date: Jul. 24, 2003

(54) Vehicle roof headliner panel and method for making same

(76) Inventor: Tony Alan Schoenwald, Mitchell, SD (US)

Correspondence Address: Tony Alan Schoenwald, 724 N. Duff St., Mitchell, SD, 57301, US

(21) Appl. No.: 10/331,542

(22) Filed: Dec. 31, 2002

Related U.S. Application Data
(60) Provisional application No. 60/349,481, filed on Jan. 18, 2002.

(51) Int. Cl. B60J 7/00

(52) U.S. Cl. 296/214

(57) ABSTRACT

A vehicle roof headliner panel for lining the interior surface of any motor vehicle, comprised of a single structure formed from a mold of the existing style of the roof of a vehicle using fiberglass matting, resin, hardener to create a high strength, better insulated safe and stylish interior vehicle compartment.

### FEDERALLY SPONSORED R+D STATEMENT

There was no sponsorship by the United States Federal Government for this invention.

### DESCRIPTION

### Background of the Invention

This invention relates to vehicle headliner panels for lining the interior surface of a vehicle roof, whether automobile, truck, construction vehicle, recreation vehicle or other motorized or non motorized vehicle with an interior wherein the roof includes a liner for finish in appearance or function or both. As well, in particular for vehicles where safety and strength is a concern such as race cars, military vehicles and construction equipment.

The interior surface of a vehicle roof is commonly and for the last seventy years been lined with a variety of materials. Some of these materials from the past include cardboard, paperboard, foam attached or encased in other binding material, corrugated paper, plastic, fabric of various types such as felt, velvet, vinyl, or leather.

As is the case when a vehicle may be involved in an accident, or as the vehicle is old and deteriorated, the owner of the vehicle would want to improve the condition of the vehicle for either using it again or to restore it to its original look. As in the case with a race car, need protection from the roof to withstand more impact during a rollover or crash. As well, individuals in higher risk locations such as mountainous regions may want more protection from falling rock, ice, or tree branches falling during a storm. Also in mountainous regions there is a risk of rolling the vehicle from sliding off an ice covered road and down a hillside and having the roof surface come in contact with jagged rocks and tree limbs which would tend to puncture the exterior of a vehicle roof.

Construction vehicles as well as automobiles and trucks are frequently in dangerous construction zones. The headliners in these vehicles are currently not a strengthening structure for the roof, but a stylish, functional finish for a variety of accessories, venting functions for HVAC, as well as interior light fixtures.

Older vehicle headliners were simply in place to cover steel and possibly wires, with absolutely no structural strength and would deteriorate quickly with time and moisture. Discoloration and fabric deterioration was inevitable. Newer model cars as can be seen from referenced patent nos. have been constructed to alleviate these deterioration concerns.

This invention addresses deterioration concerns and in addition, structural strength from the interior and exterior as safety features. The current manufacturing of headliners have improved on longevity of roof liners, but they can still be punctured from the interior and most can be cracked and destroyed from the exterior.

### SUMMARY OF THE INVENTION

Construction of the self-supporting headliner of this invention is initiated by removing the entire roof section of the same type car as the headliner will be manufactured for years up to 1982. For years 1983 to the present day, the existing headliner is removed and a mold made of it.

### EXAMPLE

If it is a new headliner needed for a Volkswagon years 1998-2002 which are all the same, a roof headliner from that year Volkswagon is used as a primary mold. A primary mold is then made of the interior surface of the roof headliner. The headliner is first removed from the car roof and laid on a platform so as to allow the inside curve of the headliner to face up. It is then primed with a top quality primer paint, smoothed, and waxed. A coating of tooling gel coat is then applied. Following the gel coat, two layers of fiberglass matting is laid onto the roof headliner extending past the edges of the roof in all directions. Resin and hardener are combined in the ratio of one quart resin to 0.75 ounces hardener. This resin is applied with a resin roller. After a period of time, the finished dry fiberglass mold is lifted from the roof assembly. This is the primary form that will receive the secondary mold. We now have an exact perfect impression of the roof headliner complete with openings for accessories and light fixtures. All openings in the primary mold are cut out and the edges trimmed to the exact edging of the headliner.

This primary mold is now inverted 180 degrees so that the concavity is facing down and the unit is set on a cart with the edges of the primary mold extending past the cart edges. The secondary or finished headliner sequence is then performed. All imperfections are sanded, filled, sanded again until perfectly smooth. A primer coat of paint is applied, wax, gel coat then one layer of fiberglass matting is laid over the surface extending past the edges of the primary mold and resin and hardener are combined in a combination of one quart resin to 0.75 ounces hardener. The resin is applied with a resin roller. The center of the headliner is located and an extra coating of resin of six inch width is applied in both directions in the center between either edge along both the length and width of the mold for added compression strength. After a period of time when the secondary mold is dry and cured, the edges are trimmed back to the primary mold edges and all accessory access and lighting holes are cut out with a utility knife. An air hose with pressurized air is blown between the interface of the primary and secondary molds and the secondary mold separates from the primary mold.

The secondary mold is an exact replica of the roof headliner and can be finished with a coat of primer, paint. Or it can be covered with fabric, foam and fabric, or leather any according to customer specifications.

### BREIF DESCRIPTION OF THE DRAWINGS

FIG. 1. Headliner taken out of vehicle.

FIG. 2. Headliner sanded, primed with paint, waxed, tooling gel coated, fiberglass matting and resin applied and dried forming primary mold.

FIG. 3. Primary mold inverted so concavity to floor, top is primed, waxed, gel coated.

FIG. 4. Secondary mold formed with one layer of fiberglass matting and resin applied.

FIG. 5. Secondary mold (new headliner) after removal by pressurized air from primary mold.

FIG. 6. New headliner (secondary mold) installed in vehicle.

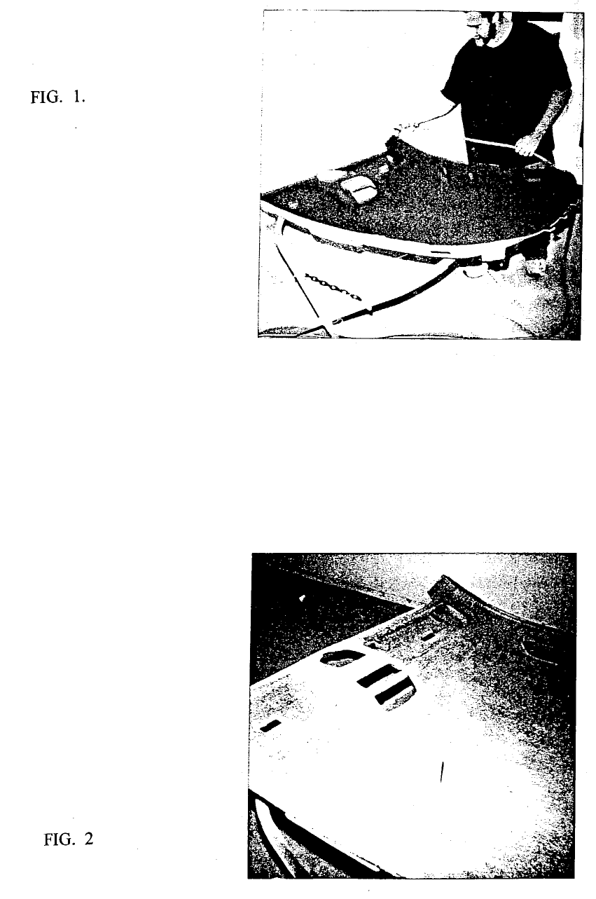

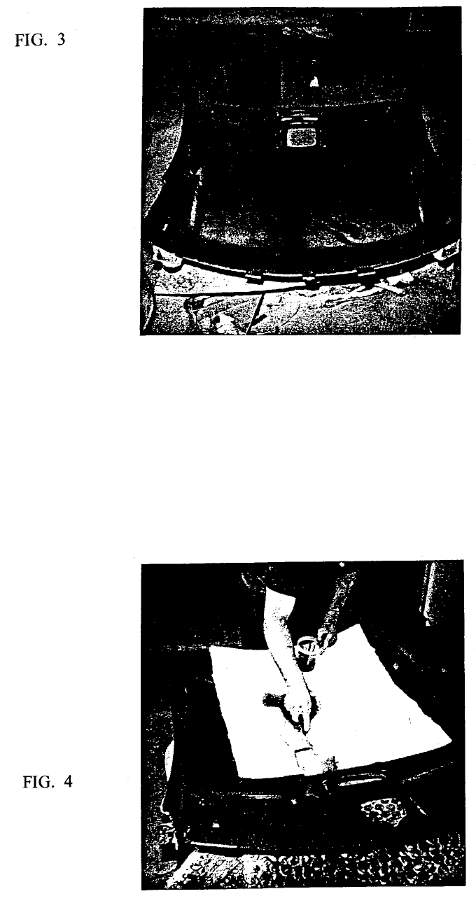

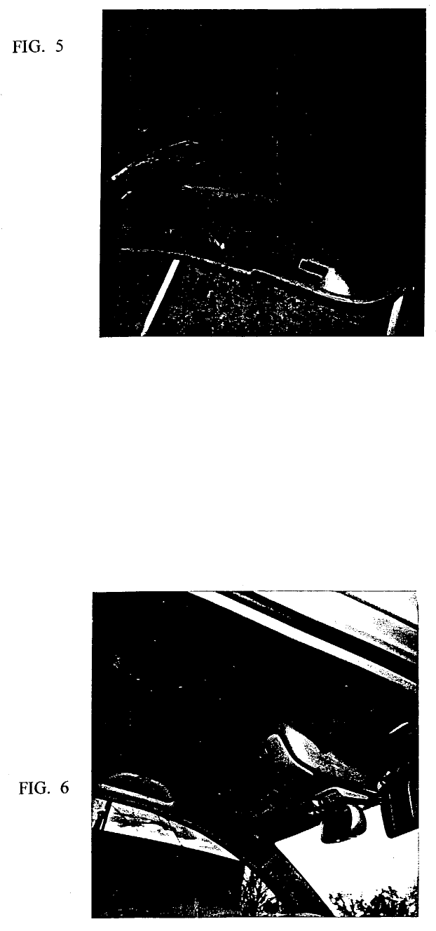

That which is claimed:

1. A self supporting headliner panel for lining the interior surface of a vehicle roof, comprised of:
A fiberglass matting, resin, hardener, when combined and dried form exactly and precisely the same design as the previous headliner, complete with access openings for insertion of accessories.

2. The self supporting headliner panel of claim 1 wherein:
The compression strength is increased to 600 psi for one single interwoven fiberglass matting layer, resin and hardener.

3. The self supporting headliner panel of claim 1 wherein:
The compression strength in increased to 1200 psi when constructed with two interwoven fiberglass matting layers, resin and hardener.

4. The self supporting headliner panel of claim 1 wherein:
The compression strength is increased to 600 psi and is 50% lighter in weight than claim 2 when constructed with carbon-fiber matting, resin and hardener.

5. The self supporting headliner panel of claim 1 can be formed for any and all models of automobiles, trucks, construction vehicle interiors dating from 1925 to the present day.

6. The self supporting headliner panel of claim 1 wherein:
It can be painted, covered with fabric or padded.

7. The self supporting headliner panel of claim 1 wherein:
It is 100% waterproof and impervious to deterioration.

8. The self supporting headliner panel of claim 1 wherein:
The strength can be increased by increasing the number of layers of fiberglass matting, resin and hardener.

9. The self supporting headliner panel of claim 1 wherein:
The strength can be increased by increasing the number of layers of carbon fiber matting, resin and hardener.
